(19) United States
(12) Patent Application Publication
(10) Pub. No.: US 2022/0258389 A1
(43) Pub. Date: Aug. 18, 2022

(54) MACHINE FOR INJECTING THERMOPLASTIC MATERIAL

(71) Applicant: Aurélien STOKY, BOUXIERES AUX DAMES (FR)

(72) Inventor: Aurélien STOKY, BOUXIERES AUX DAMES (FR)

(21) Appl. No.: 17/596,436

(22) PCT Filed: Jun. 10, 2020
(86) PCT No.: PCT/EP2020/066138

§ 371 Date: Dec. 10, 2021

(30) Foreign Application Priority Data
Jun. 13, 2019 (FR) FR1906294

(51) Int. Cl. B29C 45/03; B29C 45/18; B29C 45/53

(52) U.S. Cl. CPC B29C 45/03; B29C 45/53; B29C 45/18

(57) ABSTRACT

A machine for injecting thermoplastic material into mould includes a frame, a bracket, a melt chamber supported by the bracket, a piston designed to plunge into the melt chamber per an injection axis through an upper opening and push a molten material contained in the chamber to the mould. The machine includes a head along which the piston slides, the head also having a hopper which contains the non-melted thermoplastic material, the head being mobile perpendicularly to the injection axis between an injection position, in which the piston is aligned with the melt chamber, and the hopper is blocked off by the bracket, and a feed position, in which the hopper is aligned with the melt chamber to feed it with thermoplastic material, and the movement of the piston is limited by the bracket.

### FIELD OF INVENTION

The invention concerns a machine for injecting thermoplastic material into a mould, suitable for single parts or small series, and particularly for manual operation.

### PRIOR ART

The industrial technique for injecting synthetic material conventionally uses injection presses comprising a heat-generating body and an Archimedes' screw rotating in the body. The thermoplastic material enters one end of the screw in the form of granules and comes out of the other end under pressure in molten form. This technique is well suited for parts to be made continuously in series, but is not suitable for small series. Indeed, the press contains a large volume of material in transit, and for each change of production this volume becomes mixed with the new material. It is necessary to bleed off this material before a new production can commence. Furthermore, the initial temperature rise is long and costly in energy terms.

Machines have already been proposed to prepare and inject small volumes manually. Document GB 751,716 shows a machine comprising a frame with a column, a base supporting a mould, a bracket fixed to the column, a melt chamber supported by the bracket, a piston designed to plunge into the melt chamber along an injection axis through an upper opening and to push the molten material contained in the chamber into the mould. The opening is surrounded by a funnel into which a spout can pour the granules of material. The granules then enter the melt chamber provided the piston is raised sufficiently high.

Document U.S. Pat. No. 7,494,332 B2 shows a similar machine.

Although they can be used to make single parts or small series, both of these models have drawbacks. In particular, the introduction of the material in the form of granules is done close to the end of the piston which may be very hot. The granulated material that flows to the melt chamber can become compressed there and block the flow. It is then very delicate to intervene to clear the opening, owing to the risks of burning. Another drawback is that the piston must be held in the raised position when reloading with material. This is done by means of springs. But at the time of injection, these springs continue to compensate, which reduces the force available for generating the injection pressure. Furthermore, the melt chamber remains open during the material melting phase, which increases the thermal losses and the time required to obtain complete melting.

### DESCRIPTION OF THE INVENTION

The invention aims to provide an injection machine for small series that is easy to reload with material and whose thermal losses are limited.

With this goal in mind, the invention concerns a machine for injecting thermoplastic material into a mould, the machine comprising a frame, a bracket mounted on the frame, a melt chamber supported by the bracket, a piston designed to plunge into the melt chamber along an injection axis through an upper opening and push the molten material contained in the chamber into the mould, the machine being characterised by the fact it includes a head along which the piston slides, the head also has a hopper that contains the non-molten thermoplastic material, the head being mobile perpendicularly to the injection axis between an injection position, in which the piston is aligned with the melt chamber and the hopper is blocked off by the bracket, and a feed position in which the hopper is aligned with the melt chamber to feed it with thermoplastic material and the piston's movement is limited by the bracket.

Thanks to the invention, it is easy to reload the melt chamber. You just have to move the head to the feed position to align the hopper and the chamber, in such a way that the material contained in the hopper falls by gravity into the chamber. Furthermore, in this position, the piston's movement is limited by the bracket, which prevents it from descending. It is not necessary to provide springs to compensate for its weight and in the injection phase, all the pressing force on the piston is available.

As per a design feature, the head swivels around a column axis parallel to the injection axis between the injection and feed positions. The transition from one position to the other is obtained by swivelling the head, which is a manoeuvre that is easy to perform, using an assembly that is easy to manufacture.

As per a design feature, the bracket has a plate extending perpendicularly to the injection axis on either side of it and opposite the piston and the hopper to block off the hopper, the plate including a through hole opposite the melt chamber. The end of the piston presses against the plate when the head is in the feed position. It can also rub against it, which makes it possible to scrape the end and remove any remaining molten material, if necessary. The plate is also used to block off the hopper when the latter is not opposite the opening. This makes it possible to fill the hopper when the head is in the injection position.

As per an improvement, the chamber includes a heat insulation washer between the chamber and the plate. We thus limit the heat losses from the melt chamber and the temperature rises on the plate.

As per an improvement, the head includes a base plate extending between the piston and the hopper, flush with the bracket to block off the melt chamber where the head is in an intermediate position between the injection position and the feed position. There is therefore a position of the head in which the chamber is blocked off, the piston is kept outside of the chamber and rests on the bracket, and the hopper is blocked off. This position is particularly useful during the melting phase to limit the heat losses and speed up the melting phase.

As per a design feature, the piston is operated by an arm mounted on the head. The piston can thus be actuated manually, which is simple to do. The arm is also used to control the movement of the head.

As per a design feature, the frame includes a column that has an axis parallel to the injection axis, the bracket being mounted in such a way it can slide along the column and including a stopping system for holding the bracket in position on the column. It is thus possible to adjust the position of the melt chamber according to the size of the mould and its position.

As per an improvement, the head includes a locking system for holding the head in the injection position.

As per a design feature, the locking system is formed by a bolt passing through the head and the bracket, one of the elements of the head and of the bracket comprising a hole through which the bolt passes to enable the movement between the injection position and the feed position, the bolt being capable of being tightened to link the head and the bracket.

As per an improvement, the machine includes an end-stop system to stop the head from swivelling in the injection position and in the feed position. The positions are therefore perfectly reproducible and easy to find.

As per a special feature, the melt chamber has an injection nozzle designed to come into contact with the mould by a movement of the chamber towards the mould with respect to the bracket. The nozzle ensures an airtight connection between the chamber and the mould's cavity to fill the cavity with molten material.

As per a design feature, the machine has a return system that tends to keep the opening of the melt chamber as close as possible to the bracket, to enable the nozzle to come into contact against the mould when the piston raises the pressure. At rest, the melt chamber is pushed against the plate by the return system. When injecting, when the pressure against the piston is sufficient, the chamber moves as a whole to push the nozzle against the mould. When the pressure is released, the return system pushes the chamber back against the plate.

### BRIEF DESCRIPTION OF THE FIGURES

The invention will be better understood and other features and advantages will appear on reading the following description, the description referring to the appended drawings among which:

FIG. 1 is a perspective view of a machine conform to an implementation mode where the invention is in the feed position;

FIG. 2 is a view similar to FIG. 1 where the head is in the intermediate position;

FIG. 3 is a view similar to FIG. 1 where the head is in the injection position;

FIG. 4 is a view similar to FIG. 1 where the head is in the injection position and the piston is lowered at the end of the injection phase;

FIG. 5 is a cross-section view per the machine's injection axis with the head in the feed position;

FIG. 6 is a cross-section view per the machine's injection axis in the position shown in FIG. 4.

### DETAILED DESCRIPTION

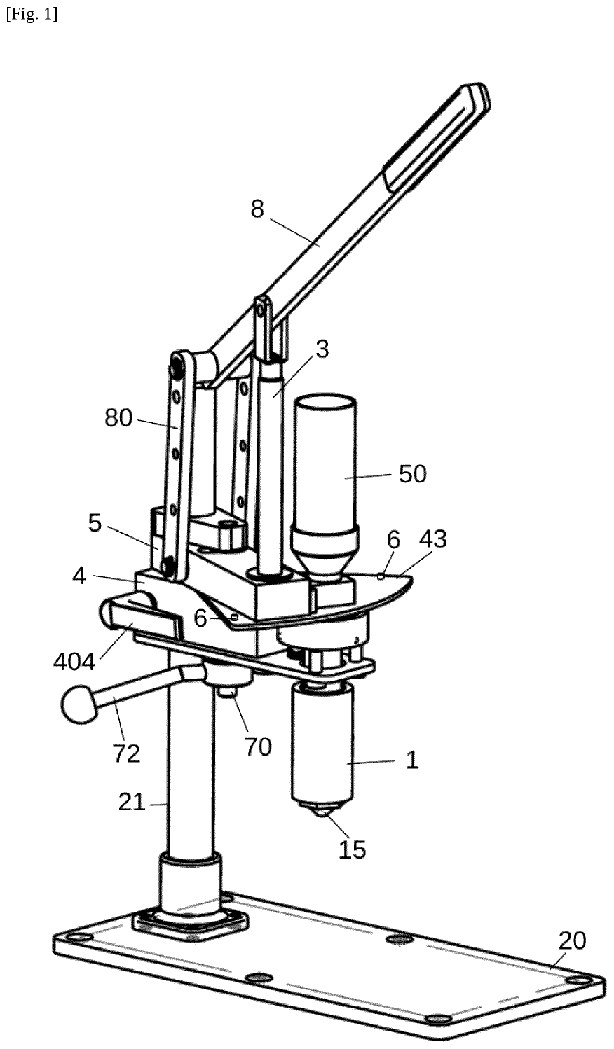

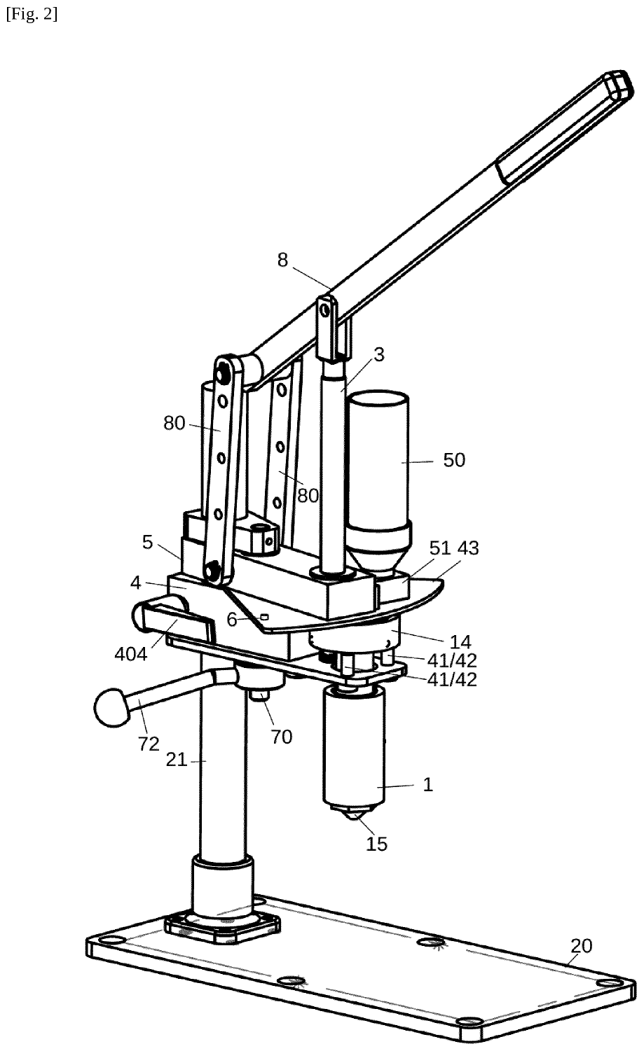

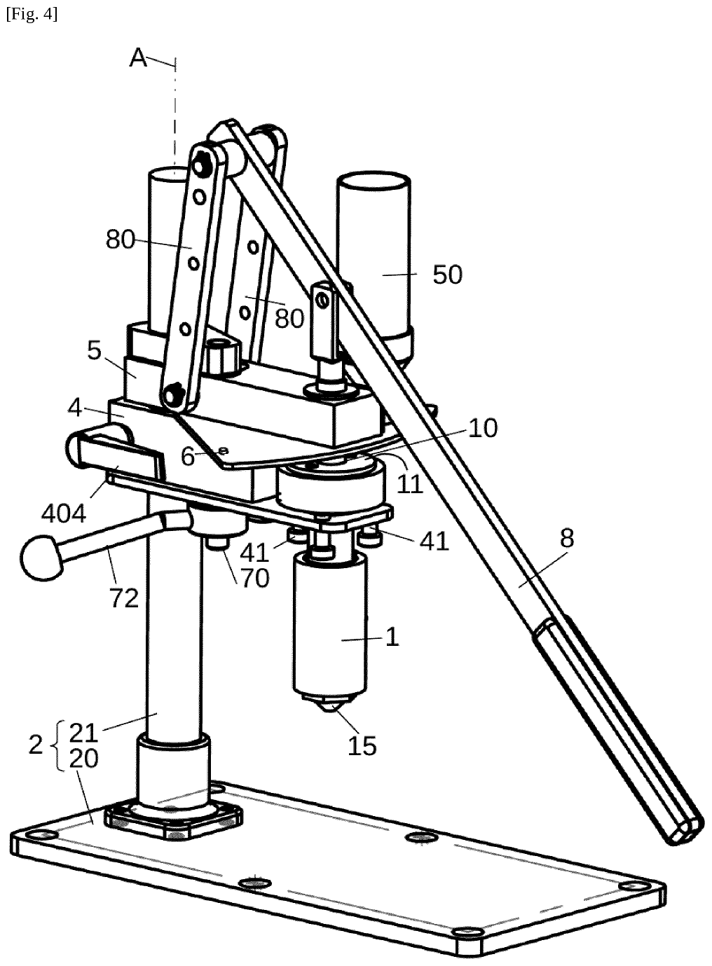

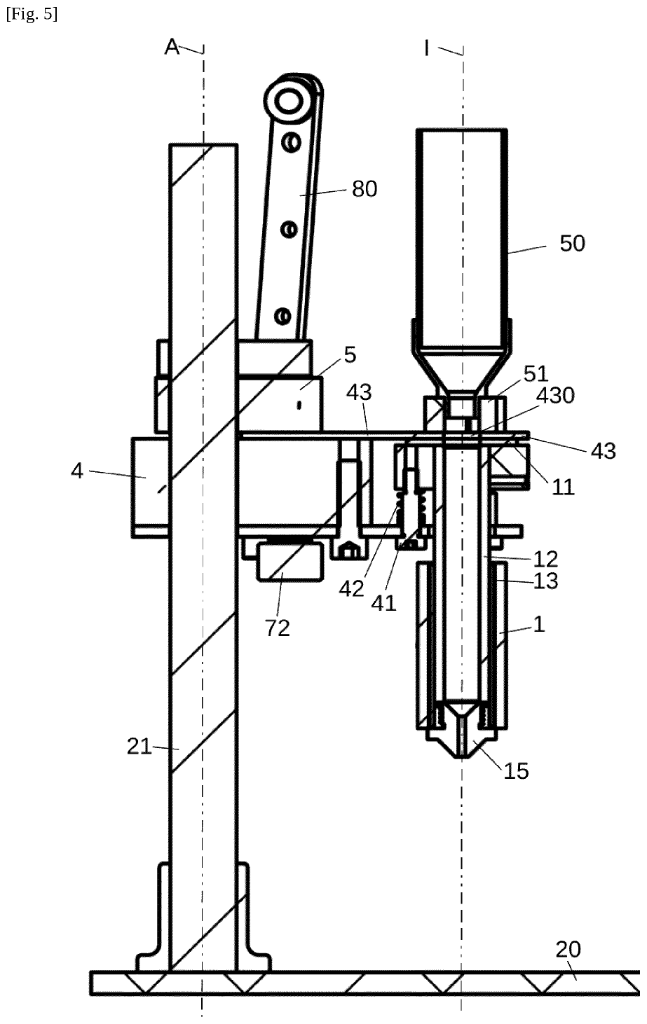

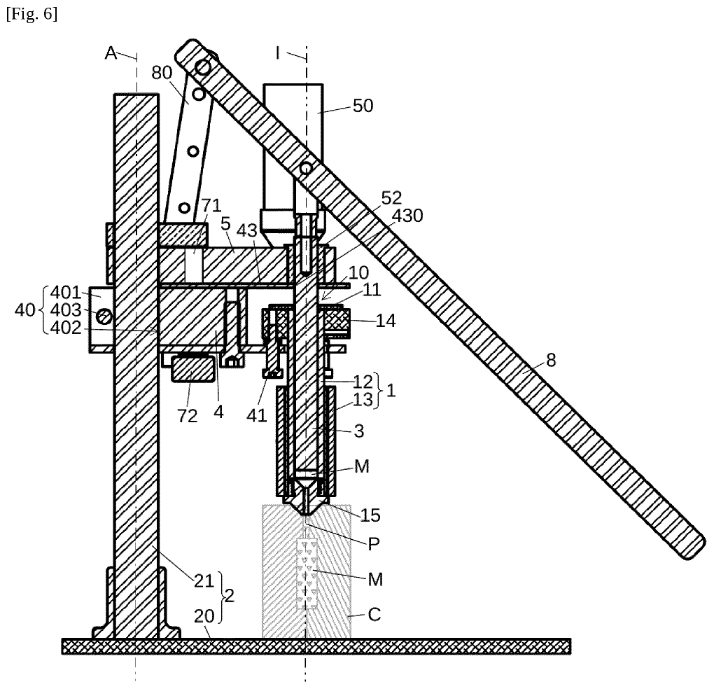

A machine used to inject thermoplastic material conform to an embodiment of the invention is shown in FIGS. 1 to 6. The machine is designed to inject molten material M into mould C, as shown in FIG. 6. Material M is fed in the form of solid particles, for example granules, by means of hopper 50 into melt chamber 1 where it is melted before being injected into mould C by piston 3.

The machine has a frame 2 including a base 20 that has a more or less flat shape designed to be placed horizontally and a column 21 that protrudes from base 20 per column axis A.

Bracket 4 slides along column 21 extending parallel to base 20 and includes a stopping system 40 to hold bracket 4 in position on column 21. The stopping system 40 has a slot 401 extending radially with respect to a bore 402 in bracket 4 which serves as the guide for bracket 4 on column 21, and a bolt 403 extending perpendicularly to the slot, bolt 403 being able to tighten bore 402 to tighten bracket 4 on to column 21. A nut on bolt 403 has a lever 404 to enable operation by hand.

Melt chamber 1 extends vertically per an injection axis I parallel to column axis A and is supported by bracket 4 by means of three small columns 41 that guide melt chamber 1 in a transfer movement per injection axis I. The small columns are fastened to a ring 14 fastened in the upper part of melt chamber 1 at the level of opening 10. The return system in the form of springs 42 placed around small columns 41 tend to maintain an opening 10 in melt chamber 1 as close as possible to plate 43 on bracket 4, in a direction opposite to base 20. Plate 43 extends perpendicularly to injection axis I in the upper part of bracket 4, that is to say opposite to base 20, and includes a through hole 430 opposite opening 10.

Melt chamber 1 has a heat insulation washer 11 between melt chamber 1 and plate 43, washer 11 being pressed against plate 43 by springs 42. Melt chamber 1 consists of a sleeve 12 with a tubular shape whose interior diameter is adjusted to the exterior diameter of piston 3, and a heater element 13 surrounding sleeve 12. The machine has an electrical regulation device, not shown, to supply heater element 13 with current and regulate the temperature inside melt chamber 1 by means of at least one temperature probe, not shown. Sleeve 12 is fastened to ring 14.

The machine also has a head 5 along which piston 3, designed to plunge into melt chamber 1 per injection axis I through upper opening 10, slides guided by bushing 52. Head 5 can swivel on column 21 around column axis A between an injection position and a feed position. A system of end stops 6 is provided to stop the swivelling of head 5 in the injection position or in the feed position. The end stops for example are two studs 6 fastened on to plate 43.

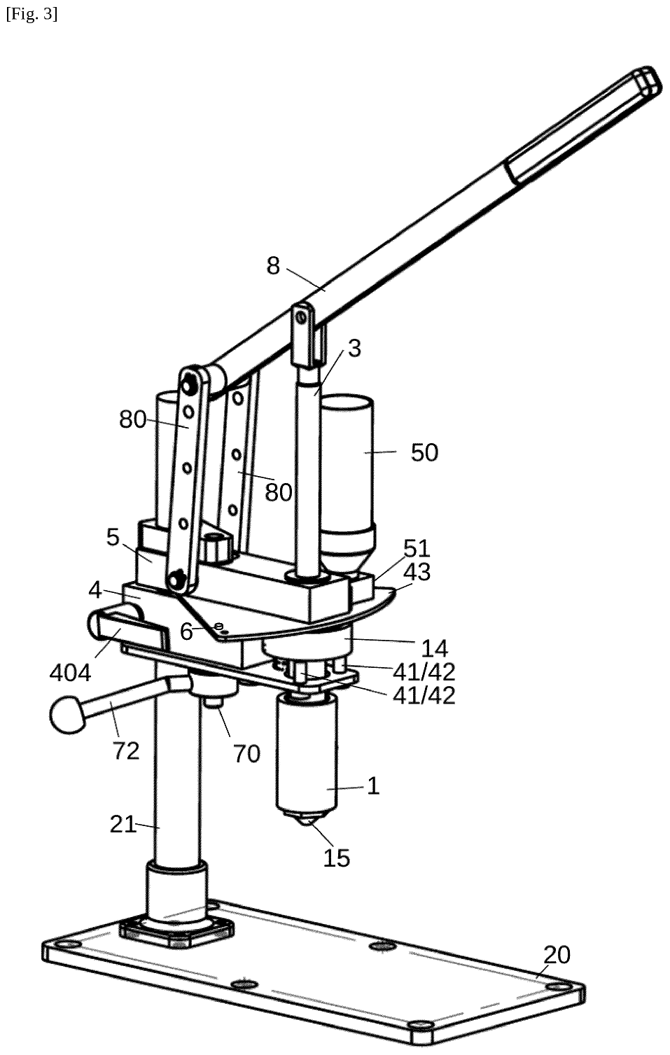

Head 5 also has a hopper 50 to contain the non-melted thermoplastic material. Hopper 50 is more or less funnel shaped, but may have a variety of shapes. Head 5 has a base plate 51 extending between piston 3 and hopper 50 flush with plate 43 of bracket 4. In the feed position, as shown in FIG. 1, hopper 50 is aligned with melt chamber 1 to feed it with thermoplastic material and the movement of piston 3 is limited by bracket 4, that is to say by plate 43 of bracket 4. In the injection position, as shown in FIG. 3, piston 3 is aligned with melt chamber 1 and hopper 50 is blocked off by bracket 4. In an intermediate position of head 5 between the injection position and the feed position, base plate 51 is opposite the hole in plate 43 of bracket 4 and blocked off by melt chamber 1.

Head 5 includes a locking system 7 for locking it in the injection position. Locking system 7 consists of bolt 70 passing through head 5 and bracket 4 that can be tightened to link head 5 and bracket 4 together. Head 5 has a hole 71 through which bolt 70 passes to enable the movement of head 5 between the injection position and the feed position. The nut on bolt 70 also has a lever 72 to enable operation by hand.

An arm 8 is connected to piston 3 swivelling around an axis perpendicular to injection axis I and to head 5 by means of two connecting rods 80 parallel with each other. So, arm 8 makes it possible to manually control the sliding of piston 3 in guide bushing 52 and in melt chamber 1.

Melt chamber 1 has an injection nozzle 15 designed to come into contact with mould C through the movement of the chamber towards mould C along small columns 41. Nozzle 15 has a blocking-off system, not shown, for closing melt chamber 1 outside of the injection phases. The blocking-off system can be controlled by various means, for example by pressing nozzle 15 on to mould C, or by raising the pressure of the material in melt chamber 1.

We are going to describe an example of the machine's operating cycle.

We consider that the initial position of head 5 is the intermediate position. In this position, hopper 50 is blocked off by plate 43 and can receive the thermoplastic material in the form of fragmented solids, for example granules. Piston 3 rests on plate 43 through the force of gravity. Mould C is in place on base 20 under melt chamber 1, with an injection hole P opposite nozzle 15. Stopping system 40 is tightened after the adjustment of the height of bracket 4 on column 21.

Regulation is started to heat melt chamber 1 up to a set temperature which depends on the material to be injected. Ring 14 serves as a thermal diffuser that limits the upwards progression of the heat. At the same time, we swivel head 5 with arm 8 to the feed position. Melt chamber 1 then fills up with the fragmented material delivered by hopper 50 passing through hole 430 and opening 10. When the chamber is full, we push head 5 back to the intermediate position and wait for the material to melt.

When the material has melted, we swivel head 5 to the injection position, and tighten locking system 7 to guarantee the injection position and stiffen bracket 4. We then lower piston 3 by means of arm 8, which compresses molten material M in melt chamber 1. While increasing the pressure on the material with piston 3, we push melt chamber 1 against the force of the springs 42 so that it moves towards base 20. Nozzle 15 then abuts against mould C and opens to allow material M to pass under pressure into mould C. Piston 3 slides in melt chamber 1 to push the material until mould C is full.

We then raise arm 8, so that nozzle 15 closes, melt chamber 1 rises to stop against plate 43 and piston 3 comes out of melt chamber 1. We loosen locking system 7 and swivel head 5 to the intermediate position. At the time of this last movement, we can leave the end of piston 3 to rub against plate 43 so as to scrape the residue of material off piston 3. The machine is ready for another cycle. If hopper 50 contains enough material, we can pass directly on to the feed position without stopping in the intermediate position.

The invention is not limited to the implementation mode that has been described as an example only. Arm 8 could swivel on head 5 and transmit its movement by means of a connecting rod or a pinion meshing with a rack. Piston 3 could be operated by an electric, hydraulic or pneumatic actuator. The end-stops could be replaced by a screw adjustment system.

1. A machine for injecting thermoplastic material into a mould, the machine comprising a frame, a bracket mounted on the frame, a melt chamber supported by the bracket, a piston designed to plunge into the melt chamber along an injection axis through an upper opening and push a molten material contained in the chamber into the mould, wherein the machine comprises a head along which the piston slides, the head further comprising a hopper that contains the non-molten thermoplastic material, the head being mobile perpendicularly to the injection axis between an injection position, in which the piston is aligned with the melt chamber and the hopper is blocked off by the bracket, and a feed position in which the hopper is aligned with the melt chamber to feed the melt chamber with the thermoplastic material and the movement of the piston is limited by the bracket.

2. The machine as per claim 1 in which head can swivel around column axis parallel to the injection axis between the injection position and the feed position.

3. The machine as per claim 1, in which the bracket comprises a plate extending perpendicularly to the injection axis on either side of it and opposite the piston and the hopper to block off the hopper, the plate including through a hole opposite the melt chamber.

4. The machine as per claim 3, in which the chamber comprises a heat insulation washer between the melt chamber and the plate.

5. The machine as per claim 1 in which the head has a base plate extending between the piston and the hopper, flush with the bracket to block off the melt chamber where the head is in an intermediate position between the injection position and the feed position.

6. The machine as per claim 1 in which the piston is operated by an arm mounted on the head.

7. The machine as per claim 1 in which the frame includes a column that has an axis parallel to the injection axis, the bracket being mounted in such a way it can slide along the column and comprising a stopping system for holding the bracket in position on the column.

8. The machine as per claim 1 in which the head includes a locking system to fasten the head in the injection position.

9. The machine as per claim 8 in which the locking system is formed by a bolt passing through the head and the bracket, one of the elements of the head and of the bracket comprising a bolt hole through which the bolt passes to enable the movement between the injection position and the feed position, the bolt being capable of being tightened to link the head and the bracket.

10. The machine as per claim 1, further comprising end-stops to stop the swivelling of the head in the injection position and in the feed position.

11. The machine as per claim 1, the melt chamber comprising an injection nozzle designed to come into contact with the mould by a movement of the melt chamber towards the mould with respect to the bracket.

12. The machine as per claim 11 in which a return system configured to keep an opening of the melt chamber as close as possible to the bracket, to enable the nozzle to come into contact against the mould when the piston raises the pressure.
